(19) United States
(12) Patent Application Publication
(10) Pub. No.: US 2024/0375965 A1
(43) Pub. Date: Nov. 14, 2024

(54) MXene compound having novel crystalline morphology, and process for fabricating a compound of MAX phase type for synthesis of said MXene compound

(71) Applicant: IMRA Europe SAS, Valbonne (FR)

(72) Inventors: Radoslaw Chmielowski, Roquefort Les Pins (FR); Gerardo Larromona, Valbonne (FR); Bruno Delatouche, Valbonne (FR); Daniel Pere, Cagnes Sure Mer (FR)

(21) Appl. No.: 18/691,205

(22) PCT Filed: Oct. 4, 2022
(86) PCT No.: PCT/IB2022/059475

§ 371 Date: Mar. 12, 2024

(30) Foreign Application Priority Data
Oct. 4, 2021 (FR) FR2110459

(51) Int. Cl. C01B 32/921; C01B 32/907

(52) U.S. Cl. CPC C01B 32/921; C01B 32/907; C01P 2002/52; C01P 2002/72; C01P 2002/85; C01P 2004/03; C01P 2004/20; C01P 2004/54; C01P 2004/61; C01P 2004/62

(57) ABSTRACT

MXene compound having a novel crystalline morphology, and process for fabricating a compound of MAX phase type for synthesis of said MXene compound. The invention firstly relates to a MXene compound advantageously having a crystalline morphology that is mostly in tablet form which may be obtained from a MAX phase precursor obtained by spark plasma sintering process whereby the powders of the mixture are insulated, and to a process for fabricating the MXene compound. The invention also relates to compound of MAX phase type obtained by spark plasma sintering process whereby the powders of the mixture are insulated. The invention also relates to a synthesis process of an MXene compound from said precursor, and to the MXene compound thus obtained advantageously having a crystalline morphology that is mostly in tablet form.

### TECHNICAL FIELD

The invention concerns lamellar MXene compounds synthesized from a precursor called MAX phase.

The invention relates to the process for fabricating the compound of MAX phase type, to the compound of MAX phase type thus obtained, to the device for implementing said process, and to a novel type of MXene compound and associated fabrication process thereof.

### PRIOR ART AND SHORTCOMINGS OF THE PRIOR ART

MXene compounds were discovered in 2011 (Naguib et al. Adv. Master. 23, 4248, 2011). This compound has the general formula Mₙ₊₁Xₙ, where n=1, 2 or 3, M is selected from among Ti, V, Cr, Zr, Nb, Mo, Hf, Sc, Mn, Y and Ta, and X is C or N. It can alternatively be called Mₙ₊₁XₙTₓ where T corresponds to a terminal group selected from among the groups O, OH, F or any other halogen, S or any other chalcogen. This compound is described and characterized in publication WO2021177712.

MXenes are lamellar compounds or 2-dimensional materials (2D) which can be delaminated to form single sheets having a repeat unit of thickness approximately one nanometre. These repeat units have the structure M-X-M, M-X-M-X-M or M-X-M-X-M-X for n=1, 2 or 3 respectively.

These materials have numerous applications in particular on account of their lamellar structure, electrical conductivity and/or property of intercalating and de-intercalating species in interplanar spaces. The MXene most researched for this purpose has the formula Ti₃C₂Tₓ.

While most publications focus on delaminated MXenes, some articles including the publication by Alhabeb et al. Chem. Mater. 29, 7633, 2017 evidence the shape of MXene particles before delamination using Scanning Electron Microscopy images (SEM). These are bulk particles having no defined geometric shape. In addition, these particles display wide dispersion both in size and shape. The structure of these particles can induce limited electrical conductivity properties and can also be limiting in terms of rate of intercalation of other species within the crystal. Poor interconnectivity can also be assumed between crystals at the time of their assembly, for example to fabricate thin layers useful for various applications. Also, the strong dispersion in size and shape of the particles does not allow thin sheets to be easily obtained after delamination having homogeneous size distribution (useful for some applications) and additional size selection operations are therefore required.

In known manner, these MXene compounds are synthesized from precursors

commonly called «compounds of MAX phase type» or «MAX phase compounds». These MAX phase compounds have the general formula Mₙ₊₁AXₙ, with n=1, 2 or 3, where M and X are the same as for MXenes, and A is selected from among Al, Si, P, S, Ga, Ge, As, Cd, In, Sn, TI and Pb. They have a structure similar to that of MXenes, but additionally comprise element A which is present in the form of a layer between the Mₙ₊₁Xₙ repeat units. To fabricate MXenes, element A is chemically removed from the precursor of MAX phase type. In most cases a MAX phase precursor is preferred where A is aluminium, the associated method consisting of chemically attacking the MAX precursor with an aqueous acid solution containing hydrofluoric acid. The aluminium is thereby removed from the space between the Mₙ₊₁Xₙ repeat units leaving the terminal groups Tₓ, with T most often being —F, —OH or ═O, attached to element M positioned outside the repeat unit. The MAX precursor is previously finely ground to ensure good yield of chemical attack. After chemical attack, the product is washed and centrifuged several times to remove excess reagent used for attack and soluble by-products such as AlF₃. Additional delamination procedures can be performed if the objective is to obtain single sheets (2D) and not three-dimensional particles of MXene. One variant of the attack process with hydrofluoric acid solution is to use a mixed solution of a fluoride salt, typically Li, and a strong acid typically HCl, such as described in the aforementioned article of 2017.

Regarding the synthesis of the MAX phase precursor, the most widespread process, in particular to produce a MXene of formula Ti₃AlC₂, is to feed a mixture of carbide or nitride powders of metal M (such as MC or MN), metal A (such as Al), and metal M in an amount necessary to reach Mₙ₊₁AXₙ stoichiometry, into a tube furnace under a stream of inert gas. In the particular case of Ti₃AlC₂, the reaction mixture is composed of powders of TiC, Al and Ti. The aluminium in the starting mixture can be in slight over-stoichiometry. The mixing of the three elements (e.g. Ti, Al and C) is normally avoided since the reaction is highly exothermal and there is a risk of explosion. The use of a tube furnace under a stream of inert gas requires a temperature rise of several hours up to temperatures in the order of 1300-1500° C., but also temperature holds of several hours at the maximum temperature. There are other synthesis processes, some having recourse to high pressures and/or conditions more difficult to control and/or using another reaction mixture.

In the publication Zhou et al., J. Mater. Scie. 40, 2099, 2005, even before the first synthesis of MXene, the authors synthesized the MAX phase precursor via spark plasma sintering (SPS) using a mixture of TiC, Ti, Al and about 20% Si in relation to Al. The mixture was fed into a graphite sample holder typical of an SPS device. A product in the form of a very compact pellet, having no porosity, was obtained. This lack of porosity makes the synthesis of MXene from said MAX phase precursor difficult and lengthy since, in the prior art, for a reasonable rate of synthesis of the MXene compound, the MAX precursor needs to be in the form of powders of sub-millimetric size, said powders being difficult to obtain from a compact pellet.

### OBJECTIVE OF THE INVENTION

The invention therefore sets out to fabricate an MXene compound having lesser dispersion of particle shape and size than in the prior art, so that in particular it is able to ensure increased speed of intercalation of species within each crystal and better interconnectivity between crystals when assembling layers of these crystals, but also able to allow, via delamination, the obtaining of sheets having more homogeneous particle size distribution than reported in the prior art.

The invention also concerns the fabrication of a MAX phase precursor especially ensuring the obtaining of said MXene compound and an associated fabrication process.

### SUMMARY OF THE INVENTION

For this purpose, the invention relates to a compound of general formula Mₙ₊₁XₙTₓ, where n=1, 2 or 3, M is selected from among Ti, V Cr, Zr, Nb, Mo, Hf, Sc, Mn, Y and Ta, X is C or N, and where T corresponds to a terminal group selected from among the groups O, OH, F or any other halogen, S or any other chalcogen, characterized in that it is in the form crystals mostly having a general tablet shape, said tablets comprise two opposite parallel surfaces of defined length (L) spaced apart by a defined height (H), and in that:
the length of the crystals in tablet form is between 1 and 15 micrometres,
the height H of the crystals in tablet form is between 0.2 and 1 micrometre, and
the flattening aspect ratio of the crystals in tablet form defined by the ratio between the length L and height H is between 5 and 50.

The compound of the invention may also include the following optional characteristics considered individually or according to all possible combination of techniques:
it has the formula Ti₃C₂Tₓ.
it is obtained from a precursor compound of MAX phase type:
   having the general formula Mₙ₊₁AXₙ, where n=1, 2 or 3, M is selected from among Ti, V, Cr, Zr, Nb, Mo, Hf, Sc, Mn, Y and Ta, A is selected from among Al, Si, P, S, Ga, Ge, As, Cd, In, Sn, TI and Pb, and X is C or N, and
   in the form of a pellet having porosity greater than 30%, preferably greater than 40%, and
   with an element ratio of M/X which is stoichiometric within a relative error lower than plus/minus 0.5%.
the precursor compound of MAX phase type has the formula Ti₃AlC₂.
the precursor compound of MAX phase type has a morphology which mostly presents the two following type of particle sections:
   rectangular flat sections with a length comprised between 1 to 20 micrometres and a height comprised between 0.5 to 2 micrometres, and/or
   rounded edge flat sections with a diagonal length comprised between 1 to 20 micrometres.

The invention also relates to a process for fabricating the compound of general formula Mₙ₊₁XₙTₓ as previously indicated, wherein it comprises two chemical attack steps of a precursor compound of MAX phase type with an aqueous acid solution.

The invention further relates to a process for fabricating the compound of general formula Mₙ₊₁XₙTₓ as previously indicated when obtained from the precursor compound of MAX phase type, wherein the precursor compound of MAX phase type is obtained by a spark plasma sintering process in a spark plasma sintering device comprising a die in graphite and two punches in graphite defining a hollow chamber, characterized in that the spark plasma sintering process comprises at least the steps of:
mixing precursor powders,
placing the previously mixed powders in a closed container in an insulating ceramic material and housed in the hollow chamber,
performing the spark plasma sintering operation, and
obtaining a pellet of the compound of MAX phase type.

The process of the invention may also include the following optional characteristics considered individually or according to all possible combination of techniques:
the container is alumina-based.
the powders are not in contact with the two punches, are not directly subjected to the applied current and are insulated from the applied pressure, the current and the pressure being those applied during the spark plasma sintering operation.
the spark plasma sintering operation comprises a heat cycle during which at least one heating rate greater than 60° C./min is applied.
the heat cycle comprises:
   a first temperature rise at a heating rate greater than 60° C./min, to a temperature comprised between 550°° C. to 700° C. hold for a period comprised between 2 to 15 minutes, followed by
   a second temperature rise at a heating rate greater than 60° C./min to a temperature comprised between 1400° C. to 1500° C. hold for a period comprised between 5 to 15 minutes.
the process comprises two chemical attack steps of the precursor compound of MAX phase type with an aqueous acid solution.

The invention also relates to spark plasma sintering device to implement the process of fabrication of the precursor compound of MAX used in the process for fabricating the compound of general formula Mₙ₊₁XₙTₓ as previously indicated, comprising a die in graphite and two punches in graphite defining a hollow chamber, characterized in that it also comprises a closed container in insulating ceramic material, for example alumina, positioned in the hollow chamber, intended to receive the powder mixture during application of the spark plasma sintering process and able to maintain the powder mixture not directly subjected to the applied current and insulated from the applied pressure, the current and the pressure being those applied during the spark plasma sintering operation.

The invention further relates to a spark plasma sintering process to fabricate a compound of MAX phase type having the general formula Mₙ₊₁AXₙ, where n=1, 2 or 3, M is selected from among Ti, V, Cr, Zr, Nb, Mo, Hf, Sc, Mn, Y and Ta, A is selected from among Al, Si, P, S, Ga, Ge, As, Cd, In, Sn, TI and Pb, and X is C or N, in a spark plasma sintering device comprising a die in graphite and two punches in graphite defining a hollow chamber, characterized in that it comprises at least the steps of:
mixing powders,
placing the previously mixed powders in a closed container in an insulating ceramic material and housed in the hollow chamber,
performing the spark plasma sintering operation, and
obtaining a pellet of the compound of MAX phase type.

The spark plasma sintering process of the invention may also include the following optional characteristics considered individually or according to all possible combination of techniques:
the container is alumina-based.
the powders are not in contact with the two punches, are not directly subjected to the applied current and are insulated from the applied pressure, the current and the pressure being those applied during the spark plasma sintering operation.
the spark plasma sintering operation comprises a heat cycle during which at least one heating rate greater than 60° C./min is applied.
the heat cycle comprises:
   a first temperature rise at a heating rate greater than 60° C./min, to a temperature comprised between 550° C. to 700° C. hold for a period comprised between 2 to 15 minutes, followed by
   a second temperature rise at a heating rate greater than 60° C./min to a temperature comprised between 1400° C. to 1500° C. hold for a period comprised between 5 to 15 minutes.

The invention also relates to a compound of MAX phase type having the general formula Mₙ₊₁AXₙ, where n=1, 2 or 3, M is selected from among Ti, V, Cr, Zr, Nb, Mo, Hf, Sc, Mn, Y and Ta, A is selected from among Al, Si, P, S, Ga, Ge, As, Cd, In, Sn, TI and Pb, and X is C or N, wherein it is obtained with the spark plasma sintering process as previously indicated, it is in the form of a pellet having porosity greater than 30%, preferably greater than 40% and its element ratio of M/X is stoichiometric within a relative error lower than plus/minus 0.5%.

The compound of MAX phase type of the invention may also include the following optional characteristics considered individually or according to all possible combination of techniques:
it has the formula Ti₃AlC₂.
its morphology mostly presents the two following type of particle sections:
   rectangular flat sections with a length comprised between 1 to 20 micrometres and a height comprised between 0.5 to 2 micrometres, and/or
   rounded edge flat sections with a diagonal length comprised between 1 to 20 micrometres.

The invention further relates to a spark plasma sintering device to implement the spark plasma sintering process of the invention as previously indicated, comprising a die in graphite and two punches in graphite defining a hollow chamber, wherein it also comprises a closed container in insulating ceramic material, for example alumina, positioned in the hollow chamber, intended to receive the powder mixture during application of the spark plasma sintering process and able to maintain the powder mixture not directly subjected to the applied current and insulated from the applied pressure, the current and the pressure being those applied during the spark plasma sintering operation.

The invention further relates to a compound of general formula Mₙ₊₁Xₙ, where n=1, 2 or 3, M is selected from among Ti, V, Cr, Zr, Nb, Mo, Hf, Sc, Mn, Y and Ta, and X is C or N, characterized in that it is fabricated from a compound of MAX phase of the invention type as previously described and/or obtained with a spark plasma sintering process of the invention as previously described.

Advantageously, in the compound of general formula Mₙ₊₁Xₙ, n=1, 2 or 3, M is selected from among Ti, V Cr, Zr, Nb, Mo, Hf, Sc, Mn, Y and Ta, X is C or N, and T corresponds to a terminal group selected from among the groups O, OH, F or any other halogen, S or any other chalcogen, it is in the form crystals mostly having a general tablet shape, said tablets comprise two opposite parallel surfaces of defined length (L) spaced apart by a defined height (H), and:
the length of the crystals in tablet form is between 1 and 15 micrometres,
the height H of the crystals in tablet form is between 0.2 and 1 micrometre, and
the flattening aspect ratio of the crystals in tablet form defined by the ratio between the length L and height H is between 5 and 50.

More advantageously it has the formula Ti₃C₂Tₓ.

The invention finally relates to a process for fabricating such compound of general formula Mₙ₊₁Xₙ, wherein it comprises two chemical attack steps of the precursor compound of MAX phase type with an aqueous acid solution.

Advantageously, the precursor compound of MAX phase type of the invention is as previously indicated and/or obtained with the spark plasma sintering process of the invention as previously indicated.

### DESCRIPTION OF THE FIGURES

Other characteristics and advantages of the invention will become clearly apparent from the description below given for illustration purposes and not at all limiting, with reference to the appended Figures in which:

FIG. 1 is a schematic illustration of the device of the invention used to implement the spark plasma sintering process (SPS) of the invention to fabricate the precursor of the invention of MAX phase type;

FIGS. 2A and 2B are scanning electron microscopy (SEM) micrographs taken with two different magnifications of ×600 and ×2500 respectively, of a cross-section of the pellet of the Max phase type precursor of the invention obtained with the spark plasma sintering process of the invention, the pellet being roughly crushed;

FIGS. 3A and 3B are scanning electron microscopy (SEM) micrographs taken with two different magnifications of ×600 and ×2500 respectively, of a prior art precursor of MAX phase type;

FIGS. 4A, 4B and 4C are scanning electron microscopy (SEM) micrographs with three different magnifications of ×600, ×2500 and ×4500 respectively, of the MXene compound of the invention obtained from the precursor of MAX phase type of the invention and with the chemical attack process of the invention, said precursor in pellet form having been roughly crushed;

FIGS. 5A, 5B and 5C are scanning electron microscopy (SEM) micrographs taken with three different magnifications of ×600, ×2500 and ×4500 respectively, of the MXene compound of formula Ti₃C₂Tₓ of the invention obtained from the precursor of MAX phase type of the invention and with the chemical attack process of the invention, said precursor in pellet form having been finely milled;

FIG. 6 is an X-ray diffractogram of the MXene compound of formula Ti₃C₂Tₓ of the invention, the boxed part corresponding to magnification of the peaks of lower intensities;

FIGS. 7A, 7B and 7C are scanning electron microscopy (SEM) micrographs taken with three different magnifications of ×600, ×2500 and ×4500 respectively of a compound of MXene type obtained by applying twofold chemical attack conforming to the invention, but applied to the prior art MAX phase precursor in FIGS. 3A and 3B.

FIG. 8 is an Energy Dispersive X-ray (EDX) spectrum of the MXene compound of formula Ti₃C₂Tₓ of the invention;

FIG. 9 is an Energy Dispersive X-ray (EDX) spectrum of a MXene compound obtained from a prior art MAX phase precursor.

FIG. 10 is an X-ray diffractogram of the MAX phase compound of the invention illustrated in FIGS. 2A and 2B.

### DETAILED DESCRIPTION OF THE INVENTION

The invention firstly relates to a MXene compound which may be obtained from a MAX phase precursor of the invention, and to a process for fabricating the MXène compound including a process and associated device of the invention for fabricating the MAX phase precursor.

The invention also relates to a first innovative process and associated device for fabricating a MAX phase precursor, said precursor subsequently being used to fabricate the MXene compound of the invention according to a second innovative fabrication process.

The process for fabricating the MAX phase precursor, particularly but not exclusively a MAX phase precursor of formula Ti₃AlC₂, is based on the known technique of Spark Plasma Sintering SPS.

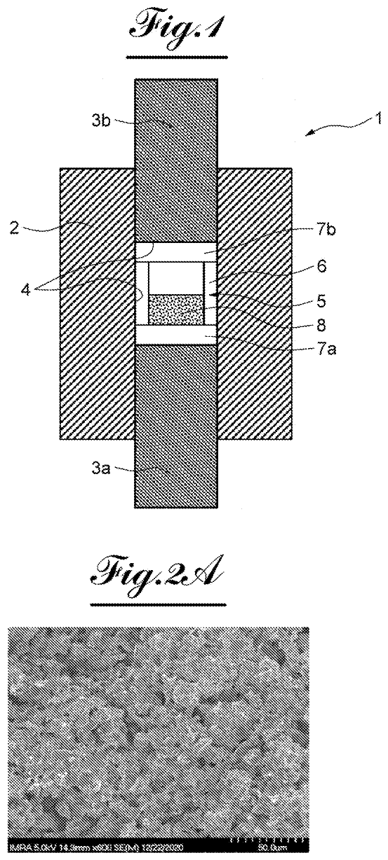

With reference to FIG. 1, also in known manner, this process involves the use of a device 1 comprising a graphite die 2 and respective lower 3a and upper 3b punches delimiting a hollow chamber 4. This sole configuration corresponds to SPS equipment widely sold and used to carry out this sintering technique.

In the invention, the device 1 further comprises a closed hollow container 5 housed in the hollow chamber 4 and composed of a hollow cylinder 6 in insulating material resistant to high temperatures and chemically neutral, and of disc-shaped lower 7a and upper 7b covers in the same material and affixed to the two ends of the hollow cylinder 6. For example, the hollow cylinder 6 and the covers 7a,7b can be in alumina or in another insulating ceramic material. The mixture of powders used to synthesize the MAX phase precursor is placed in the hollow container in alumina 5. The known operations of applying a vacuum and of temperature rise are then applied. After cooling a pellet is obtained of cylindrical shape.

To synthesize a MAX phase precursor of composition Ti₃AlC₂, commercially available powders are used of titanium, aluminium and titanium carbide which are mixed in an agate mortar. The mixture is passed through a ball mill for finer mixing of the three components. The composition of the Ti:Al:TiC mixture can be stoichiometric (element ratio of 1:1:2 respectively within a relative error lower than plus/minus 0.5%), but preferably with a slight excess of aluminium, in particular with a element ratio of 1:1.1:2 respectively. In other words, element ratio of Ti/C is stoichiometric within a relative error lower than plus/minus 0.5%.

The mixture of powders is loaded in the hollow alumina container 5 of the device in FIG. 1, the hollow cylinder 6 and lower cover 7a thereof already being in position. The powders are compacted in the hollow container 5 after which the upper cover 7b of the container 5 and upper punch 3b in graphite are placed in position. A vacuum is applied followed by a heat cycle comprising a rapid rise (of about 15 to 30 min) up to a temperature of about 1400 and 1600° C., more particularly 1450° C., for a time of between 5 and 15 min. More generally, the heating rates is greater than 60° C./min. More particularly, the heat cycle comprises a first temperature rise at a heating rate greater than 60° C./min, to a temperature comprised between 550° C. to 700° C. hold for a period comprised between 2 to 15 minutes, followed by a second temperature rise at a heating rate greater than 60° C./min to a temperature comprised between 1400°° C. to 1500° C. hold for a period comprised between 5 to 15 minutes.

A porous pellet of cylindrical shape is obtained. This porosity is essential for synthesis of the MXene compound as will be seen below.

As will be detailed in counter-example 1, synthesis tests of a MAX phase precursor using the prior art SPS technique (without the hollow container in alumina) were carried out. For these tests, the mixture of powders was loaded in the assembly formed by the die and punches in graphite. According to XRD analyses, these tests led to a mixture of the MAX phase with other peaks of non-identified crystalline phase. The strong presence was also ascertained of titanium carbide TiC. In addition, the pellet was very dense, compact and without porosity. It was difficult to crush and chemical attack difficult to perform.

These differences between the MAX phase precursor obtained with the known SPS technique and the MAX phase precursor obtained with the process and device of the invention can be attributed to several factors. With use of the conventional SPS technique, an additional reaction of the powder mixture with the carbon of the assembly of parts in graphite could take place. Additionally, or concomitantly, the powder mixture is subjected to high pressure of same magnitude as that applied to the graphite punches. Also concomitantly, the electric current circulates in the powder reaction mixture which could cause phenomena of electromigration of one of the components.

Therefore, contrary to usual use of an SPS device, in the invention the powder mixture is not in contact with the graphite, is not directly subjected to the applied current and is insulated from applied pressure. This allows an innovative MAX phase precursor to be obtained in the form of a porous pellet allowing the synthesis of an MXene compound having a specific crystalline configuration as will be seen below.

The second process of the invention is a process to synthesize an MXene compound via chemical attack of the MAX phase precursor obtained with the previously described process of the invention. Chemical attack is performed using aqueous solutions of hydrofluoric acid. More particularly, aqueous solutions of hydrofluoric acid are used that are formed in situ, still further particularly a mixture of a fluoride salt such as lithium fluoride and a strong acid such as hydrochloric acid, the concentration of fluorine species being less than 5 M.

In the invention, at least two chemical attacks are performed, each additional attack step consisting of recovering the product and renewing attack with the hydrofluoric acid solution.

A MXene compound is obtained, in particular of formula Ti₃C₂Tₓ, having a morphology composed of crystals mostly in tablet form. These tablets have two planar, parallel surfaces and a flattening aspect ratio defined by the ratio between the length L and height H of a tablet of between 5 and 50, on average of approximately 10. Crystal size distribution is relatively homogeneous with a large majority of crystals having a length of between 1 and 15 microns, and height H of between 0.2 and 1 micron. This distribution and the flattening aspect ratio are respectively evaluated by counting distances measured in Scanning Electron Microscopy (SEM) images, and by measurements taken on SEM images.

This fabrication process of the MXene compound by twofold chemical attack was applied to the finely milled MAX phase precursor of the invention, but also to the roughly crushed MAX phase precursor of the invention. As will be seen below in detail, an increase is observed in the size dispersion of the particles when the MAX phase precursor is finely milled before chemical attack, the morphology of the majority of crystals remaining the same in both cases in the form of tablets such as previously defined.

This same process of fabrication of the MXene compound via twofold chemical attack was also applied for comparison purposes to commercial MAX phase precursors. The morphology of the MXene compound obtained fully differs from that of the invention (Counter-example 2 and FIGS. 7A, 7B and 7C). These results show that the obtaining of the MXene compound of the invention in tablet form is related to the specificity of the MAX phase precursor of the invention which appears to induce this special crystalline morphology of the MXene compound of the invention, the two subsequent chemical attacks preventing degradation of this crystalline form.

The morphological characteristics are evidenced by Scanning Electron Microscopy (SEM) images via visual observation and via measurements of a plurality of crystals in several samples, observation and measurements being carried out at several points in each sample. To the knowledge of the inventors, to date there does not exist a reliable quantitative technique as an alternative to imaging for measuring the flattening aspect ratios and particle size distributions when particles are far from approximating a spherical particle and when they are difficult to place in liquid suspension on account of their large size.

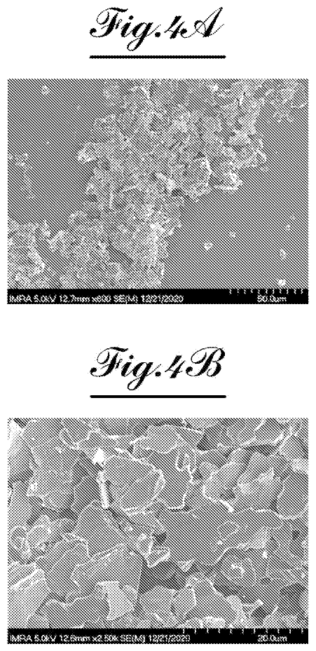

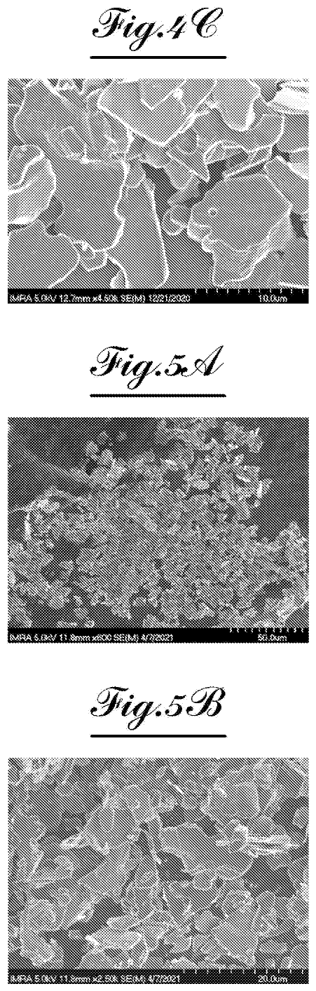

An example of the morphology of the crystals of the MXene compound of the invention is given in FIGS. 4A, 4B and 4C which illustrate SEM images at several magnifications of the Ti₃C₂Tₓ compound of the invention with the previously described crystalline morphology.

Confirmation that the compound obtained with the process of the invention

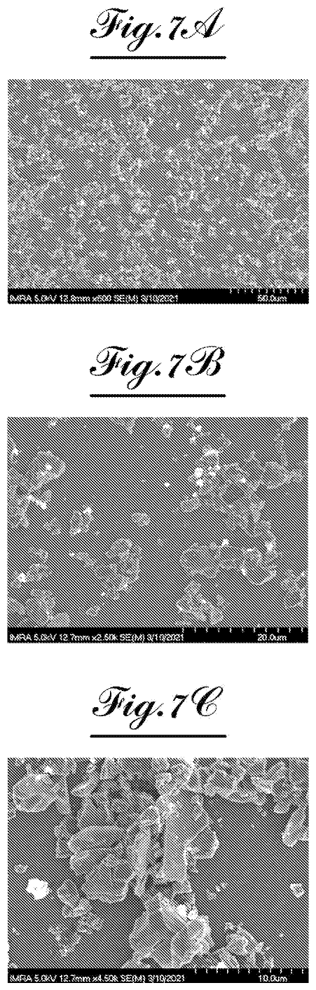

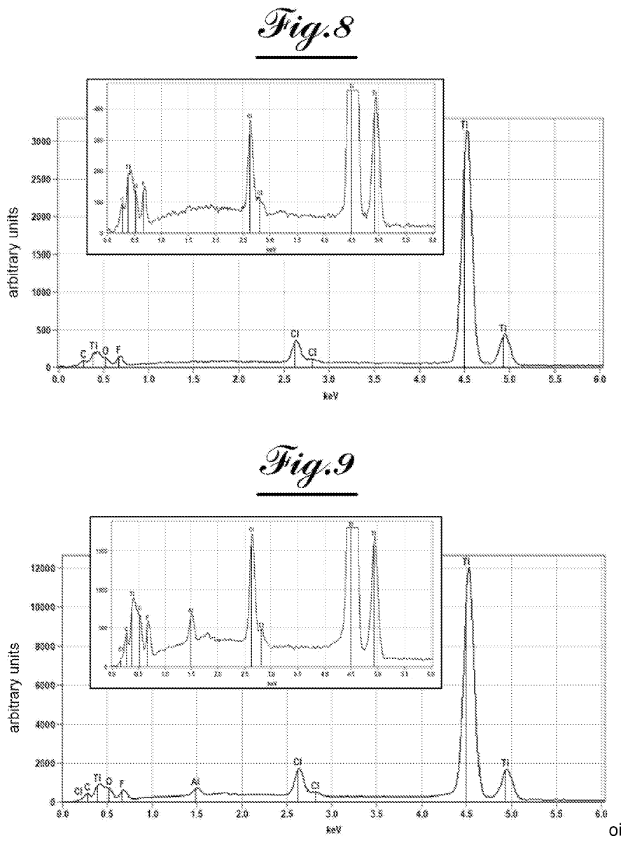

corresponds to a compound of «MXene» type, in particular having the composition Ti₃C₂Tₓ, was obtained with two techniques: by analysis of the crystalline phase via X-ray powder diffraction (XRD) with Cu Kα radiation source (FIG. 6), and via Energy-Dispersive X-ray spectroscopy (EDX) with an EDX detector incorporated in SEM apparatus (FIG. 8).

As illustrated in FIG. 6, the X-ray diffractogram of the MXene compound of the invention obtained with the previously described process is characterized by a large peak referenced 9 located between angles 2θ 6.5° and 6.9°. It corresponds to plane (hkl)=(002), joined to the interplanar distance of the lamellar planes composed of Ti₃C₂Tₓ units. Peaks of lesser density and larger angle can also be seen; they mostly correspond to replicas of plane (002), hence to multiples of the angle of the main peak.

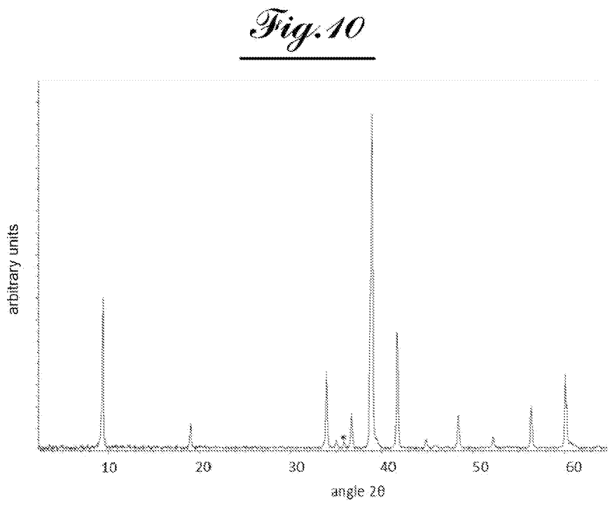

Elementary analysis of the MXene compound of the invention of formula Ti₃C₂Tₓ was obtained by Energy-Dispersive X-ray (EDX) spectroscopy. With reference to FIG. 8, EDX shows a composition of Ti and C and absence of Al (no peak at ˜1.5 keV, contrary to the EDX in FIG. 9 of a MXene compound obtained from a prior art MAX phase precursor) which corresponds to the main structural unit of the MXene compound of composition Ti₃C₂, plus the elements O, F and CI corresponding to a mixture of Tₓ terminal groups corresponding to the groups —OH or ═O, —F and —Cl. Quantitative EDX analysis of the samples, obtained following the procedure in Example 2 below, show atomic ratios of the elements forming the terminal groups in relation to Ti, i.e. Cl/Ti, F/Ti and O/Ti, of 0.05, 0.5 and 0.4 respectively and on average.

The composition of the terminal groups Tₓ can differ or one type of terminal group may not be present by modifying synthesis or post-treatment conditions, but the compound obtained nevertheless remains a compound of MXene type, in particular Ti₃C₂Tₓ. The absence of aluminium is to be noted in the MXene compound, contrary to when chemical attack only comprises one step even if it lasts a long time (more than 48 h), and even though the strongly acid medium and excess F compared with the MAX phase precursor are still present at the end of the attack step. In this case, it was observed that for a single chemical attack the Al/Ti ratio is about 0.01, which corresponds to the Al/Ti ratio of between 0.003 and 0.01 in the aforementioned publication by Alhabeb et al, 2017.

### EXAMPLE 1

### Synthesis of the MAX Phase Precursor of Composition Ti₃AlC₂

Spark plasma sintering equipment was used marketed under the name Dr. SINTER Lab. Jr. (model: SPS-211Lx) by Fuji Electronic Industrial Co. Ltd. The device was modified according to the invention as described with reference to FIG. 1, maintaining the graphite die 2 and the two graphite punches 3a and 3b but adding, to the hollow chamber 4, the hollow alumina cylinder 6 and upper 7a and lower 7a alumina discs forming a hollow alumina container 5. The powder mixture described below was loaded into the container 5, compacted and held electrically insulated from the current circulating in the graphite punches and die. The mixture was also held insulated from the pressure applied by the punches, and remained without contact with the graphite throughout the entire operating time.

Commercial powders of titanium, aluminium and titanium carbide were mixed

in an agate mortar in respective element proportions of 1:1.1:2, the powder mixture having a total weight of about 5 grams. The mixture was placed in a ball mill with tungsten carbide bowl and balls for a time of 1 hour 15 minutes and milled at a rate of 300 rpm. 1 gram of the milled powder was placed inside the hollow cylinder 6 with the lower cover 7a already in position in the device. The powers were compacted and the upper cover 7b positioned at the top end of the hollow cylinder 6 thereby forming a hollow container 5. With the upper punch 3b in graphite in position, the entire assembly 1 was placed in the SPS equipment and the vacuum applied. The following heat cycle was applied: temperature rise to 580° C. in 6 min, temperature hold at 580° C. for 5 min, temperature rise to 1450° C. in 12 min, and temperature hold at 1450° C. for 8 min. On completion of the heat cycle, the temperature drops rapidly to below 580° C. in about 5 to 10 min. A porous pellet of cylindrical shape is obtained. The porosity of the pellet is higher than 30%, most often higher than 40%, event most often about or more than 50%. This porosity is evaluated by the difference between the measured volume of the pellet and the volume of compact material calculated from the theoretical density and weight of the pellet.

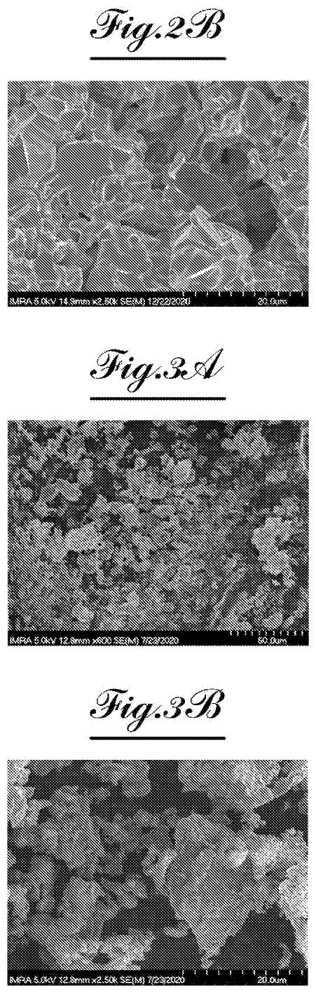

FIGS. 2A and 2B illustrate the morphology of the MAX phase precursor obtained with the invention after rough crushing of the porous pellet. These images are compared with those in FIGS. 3A and 3B of commercial powders of MAX phase compound. A distinct difference is ascertained between the two compounds. For the precursor of the invention, the particles are joined together. On the contrary, the prior art MAX phase compound is characterized by clusters of particles with large dispersion of particle size (between tens of nanometres and tens of micrometres). The images in FIGS. 3A and 3B are similar to the MAX phase compounds such as obtained and published in the literature.

Furthermore, as illustrated in FIG. 2B, the MAX phase according to the invention shows welded particles that exhibit sections that look like the particle shape of the MXenes obtained after the chemical attacks. In particular, a large number of particle sections appear to have, depending on the orientation of the section in the crushed part, either rectangular flat sections with a length comprised between 1 to 20 micrometres and a height comprised between 0.5 to 2 micrometres, or rounded edge flat sections with a rounded outline with with a diagonal length comprised between 1 to 20 micrometres, the estimation of these dimensions being approximate since the particles of this MAX phase are not isolated but welded.

With reference to FIG. 10, the X-ray diffractogram with Cu Kα radiation source of the MAX phase compound of the invention obtained in this example corresponds to the crystalline phase of the Ti₃AlC₂ compound to which is added a peak of low intensity at angle 2θ 36.0° attributed to the titanium carbide phase contained in the initial powder. This titanium carbide phase is estimated to be less than 5% by volume of the crystalline phases in the MAX phase compound.

EDX spectra of the MAX phase compound of the invention show the presence of the three elements contained in the composition of this MAX phase, namely titanium, aluminium and carbon, and the absence of impurities such as oxygen or any other element.

### COUNTER-EXAMPLE 1

### Attempted Fabrication of the MAX Phase Precursor of Composition Ti₃AlC₂ in a Prior Art SPS Device

The powder mixture such as described and prepared in Example 1 was loaded in commercial spark plasma sintering apparatus such as the one Example 1. The apparatus was not modified contrary to the apparatus used in Example 1. The powder was placed in the hollow graphite chamber which is subjected to passing current and pressure. Several heating parameters were tested such as the maximum hold temperature (between 1150° and 1450° C.), temperature hold time (between 8 and 24 minutes) and addition of an intermediate hold at 650° C. For all these tests, a very compact pellet was obtained having no porosity. This pellet was unsuitable for subjection to one or more chemical attacks to fabricate an MXene compound on account the extensive compactness thereof.

In addition, the composition of the pellet obtained analysed by X-ray diffractometry was high in titanium carbide to the detriment of Ti₃AlC₂ which it is desired to obtain.

Other tests were conducted by adding 20 atomic % of Si relative to Al in the powder mixture (following the example in the publication by Zhou et al., J. Mater. Scie. 40, 2099, 2005). The pellets obtained were also highly compact without any porosity. In addition, analyses by X-ray diffractometry show that the product is apparently of formula Ti₃(Al₁₋ₓSiₓ)C₂ with the presence of an additional non-identified phase.

Therefore, the prior art sintering technique by spark plasma sintering does not allow a MAX phase compound to be obtained allowing subsequent synthesis of a MXene compound.

### EXAMPLE 2

### Fabrication of a MXene Compound of Formula Ti₃C₂Tₓ from the Roughly Crushed MAX Phase Precursor in Example 1

The porous pellet of Ti₃AlC₂ obtained in Example 1 was roughly crushed in an agate mortar leaving mostly clusters of about 1-2 millimetres. First chemical attack was carried out with a hydrofluoric acid solution formed in situ. To do so, 0.5 grams of the MAX phase compound of formula Ti₃AlC₂ obtained in Example 1 were placed in a Teflon centrifuge tube of about 50 ml capacity, to which were added 10 mL of a previously prepared aqueous solution containing 2M lithium fluoride and 6M hydrochloric acid; the mixture was left under agitation with a magnetic stirrer at ambient temperature for 5 min. Agitation was continued by placing the tube in a temperature-controlled bath at 35° C. for about 72 hours.

After this first attack, deoxygenated water was added up to a level of about 35 mL, and centrifuging at 9000 rpm carried out for 10 to 15 minutes, after which the supernatant was evacuated to maintain the precipitate. The second chemical attack was then carried out by pouring onto the precipitate between 10 and 20 mL of the same aqueous solution containing 2M lithium fluoride and 6M hydrochloric acid, followed by agitation in a temperature-controlled bath at 35° C. for about 72 hours.

On completion of this second chemical attack, rinsing steps were performed with addition of deoxygenated water (typically 200 mL) under agitation for 5 minutes, followed by centrifugation at 9000 rpm for 10 to 15 minutes evacuating the supernatant to maintain the precipitate. This operation was repeated about 5 times until the pH of the supernatant was 4.5 or higher. The precipitate was then washed in ethanol at two steps of rinsing and centrifugation with ethanol, then stored with covering of ethanol. Alternatively, the precipitate can be dried by vacuum heating at a temperature of between 40 and 120° C.

In this manner, a MXene compound is obtained of formula Ti₃C₂Tₓ or more generally Ti₃C₂. FIGS. 4A, 4B and 4C illustrate the crystalline morphology of this compound. It is ascertained that it is composed of crystals separated from each other with morphology in the form of tablets having two planar and parallel surfaces. The flattening aspect ratio (ratio between the length L and height H of the crystals) is between 5 and 50, on average about 10. The size distribution of the crystals is relatively homogeneous: the length L of the crystals is between 1 and 15 microns, for a height of between 0.2 and 1 micron.

The X-ray diffractogram in FIG. 6, as previously explained, is characterized by a large peak referenced 9 located between angles 2θ 6.5° and 6.9° . It corresponds to plane (hkl)=(002), joined to the interplanar distance of the lamellar planes composed of Ti₃C₂Tₓ units

The EDX spectrum (FIG. 8) of this same compound shows the presence of two main elements present in the composition of this compound of MXene type, namely titanium and carbon, plus the presence of fluorine, oxygen and chlorine which could correspond to the terminal groups Tₓ, in particular groups —F, —Cl, ═O or —OH. The EDX spectrum, as previously mentioned, also shows the absence of element Al, which means that the entirety of the MAX phase precursor has been attacked and there does not remain any sub-product containing aluminium such as the oxide Al₂O₃.

### EXAMPLE 3

### Fabrication of a MXene Compound of Formula Ti₃C₂Tₓ from the Finely Crushed MAX Phase Precursor in Example 1

The porous pellet of Ti₃AlC₂ obtained in Example 1 was crushed in an agate mortar and then finely milled. The powder was passed through a sieve of 50 μm mesh size. A powder having a particle size of less than 0.50 μm was thus obtained. The same procedure of twofold chemical attack and rinsing such as described in Example 2 was applied.

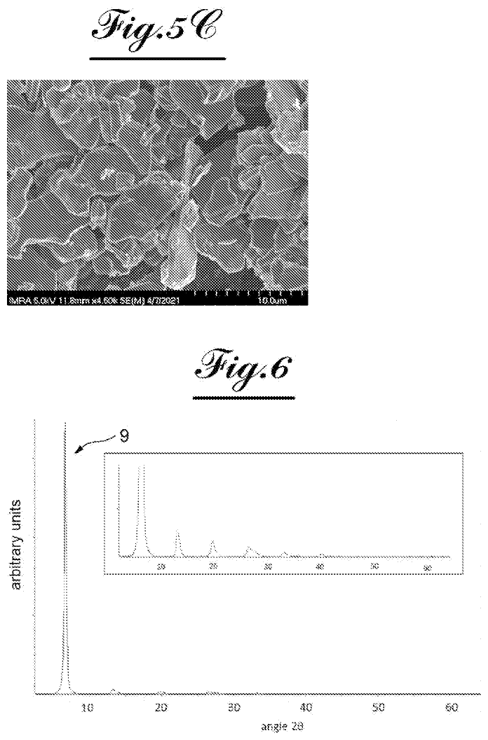

FIGS. 5A, 5B and 5C illustrate the crystalline morphology of this compound. It is ascertained that it is also composed of crystals separated from each other with morphology in the form of tablets having two planar and parallel surfaces. The flattening aspect ratio (ratio between the length L and height H of the crystals) is also between 5 and 50, on average about 10. The size distribution of the crystals is relatively homogeneous: the length L of the crystals is between 1 and 15 microns, for a height H of between 0.2 and 1 micron. Nevertheless, the strong presence is ascertained of crystals having a size of about 1 micron or less, these crystals often being of bulk shape (height H of the same order as the length L) instead of in tablet form. However, most of the crystals are in tablet form.

The X-ray diffractogram and EDX spectrum are the same as those described in Example 2.

### COUNTER-EXAMPLE 2

### Fabrication of the MXene Compound of Formula Ti₃C₂Tₓ from a Prior Art MAX Phase Precursor Ti₃AlC₂

Two batches were used of commercial MAX phase precursors sold under the name Ti₃AlC₂. They both had the appearance of a fine powder with a particle size less than about 50 microns. The SEM images of these compounds (FIGS. 3A and 3B) show non-homogeneous dispersion of particle size from several tens of microns to several tens of nanometres.

The same procedure was applied to each batch of twofold chemical attack and rinsing such as described in Example 2.

FIGS. 7A, 7B and 7C illustrate the crystalline morphology of the MXene compound obtained. The compound is mostly composed of particles and particle clusters of bulk shape (length of the same order as height). A very small minority of these particles are in tablet form. The dispersion of particle size is highly non-homogeneous, from several tens of microns to several tens of nanometres. This morphology was the same in both batches of MAX phase precursors used. This morphology also conforms to the morphology reported in the literature.

The X-ray diffractograms of the two MXene compounds obtained are similar to the diffractogram of the compound of the invention obtained in Example 2. The EDX spectra (FIG. 9) show the presence of the two main elements contained in the composition of this compound of MXene type, namely titanium and carbon, plus the presence of fluorine, oxygen and chorine which could correspond to the terminal groups Tₓ, in particular groups —F, —Cl, ═O or —OH, as is the case for the compound obtained in Example 2.

On the other hand, these spectra also show the presence of aluminium as impurity, contrary to the MXene compound of the invention in Examples 2 and 3 (FIG. 8). The Al/Ti atomic ratio is evaluated from the EDX spectra (such as the one in FIG. 9) acquired in images comprising many particles of between 0.03 and 0.04. EDX analyses on individual particles show that aluminium is chiefly present as sub-micrometric particles of aluminium oxide; it is no doubt the compound Al₂O₃.

1. A compound of general formula Mₙ₊₁XₙTₓ, where n=1, 2 or 3, M is selected from among Ti, V Cr, Zr, Nb, Mo, Hf, Sc, Mn, Y and Ta, X is C or N, and where T corresponds to a terminal group selected from among the groups O, OH, F or any other halogen, S or any other chalcogen, characterized in that it is in the form crystals mostly having a general tablet shape, said tablets comprise two opposite parallel surfaces of defined length (L) spaced apart by a defined height (H), and in that:
the length of the crystals in tablet form is between 1 and 15 micrometres,
the height H of the crystals in tablet form is between 0.2 and 1 micrometre, and
the flattening aspect ratio of the crystals in tablet form defined by the ratio between the length L and height H is between 5 and 50.

2. The compound according to claim 1, wherein it has the formula Ti₃C₂Tₓ.

3. The compound according to claim 1, characterized in that it is obtained from a precursor compound of MAX phase type:
having the general formula Mₙ₊₁AXₙ, where n=1, 2 or 3, M is selected from among Ti, V, Cr, Zr, Nb, Mo, Hf, Sc, Mn, Y and Ta, A is selected from among Al, Si, P, S, Ga, Ge, As, Cd, In, Sn, Tl and Pb, and X is C or N, and
in the form of a pellet having porosity greater than 30%, preferably greater than 40%, and
with an element ratio of M/X which is stoichiometric within a relative error lower than plus/minus 0.5%.

4. The compound according to claim 3, wherein the precursor compound of MAX phase type has the formula Ti₃AlC₂.

5. The compound to claim 3, wherein the precursor compound of MAX phase type has a morphology which mostly presents the two following type of particle sections:
rectangular flat sections with a length comprised between 1 to 20 micrometres and a height comprised between 0.5 to 2 micrometres, and/or
rounded edge flat sections with a diagonal length comprised between 1 to 20 micrometres.

6. A process for fabricating the compound according to claim 1, wherein it comprises two chemical attack steps of a precursor compound of MAX phase type with an aqueous acid solution.

7. A process for fabricating the compound according to claim 3, wherein the precursor compound of MAX phase type is obtained by a spark plasma sintering process in a spark plasma sintering device (1) comprising a die (2) in graphite and two punches (3a,3b) in graphite defining a hollow chamber (4), characterized in that the spark plasma sintering process comprises at least the steps of:
mixing precursor powders,
placing the previously mixed powders in a closed container (5) in an insulating ceramic material and housed in the hollow chamber (4),
performing the spark plasma sintering operation, and
obtaining a pellet of the compound of MAX phase type.

8. The process according to claim 7, wherein the container (5) is alumina-based.

9. The process according to claim 7, wherein the powders are not in contact with the two punches (3a,3b), are not directly subjected to the applied current and are insulated from the applied pressure, the current and the pressure being those applied during the spark plasma sintering operation.

10. The process according to claim 7, wherein the spark plasma sintering operation comprises a heat cycle during which at least one heating rate greater than 60° C./min is applied.

11. The process according to claim 7, wherein the heat cycle comprises:
a first temperature rise at a heating rate greater than 60° C./min, to a temperature comprised between 550°° C. to 700°° C. hold for a period comprised between 2 to 15 minutes, followed by
a second temperature rise at a heating rate greater than 60° C./min to a temperature comprised between 1400°° C. to 1500° C. hold for a period comprised between 5 to 15 minutes.

12. The process according to claim 7, wherein it comprises two chemical attack steps of the precursor compound of MAX phase type with an aqueous acid solution.

13. A spark plasma sintering device to implement the process of fabrication of the precursor compound of MAX used in the process of claim 7, comprising a die (2) in graphite and two punches (3a,3b) in graphite defining a hollow chamber (4), characterized in that it also comprises a closed container (5) in insulating ceramic material, for example alumina, positioned in the hollow chamber (4), intended to receive the powder mixture during application of the spark plasma sintering process and able to maintain the powder mixture not directly subjected to the applied current and insulated from the applied pressure, the current and the pressure being those applied during the spark plasma sintering operation.

14. A spark plasma sintering process to fabricate a compound of MAX phase type having the general formula Mₙ₊₁AXₙ, where n=1, 2 or 3, M is selected from among Ti, V, Cr, Zr, Nb, Mo, Hf, Sc, Mn, Y and Ta, A is selected from among Al, Si, P, S, Ga, Ge, As, Cd, In, Sn, Tl and Pb, and X is C or N, in a spark plasma sintering device (1) comprising a die (2) in graphite and two punches (3a,3b) in graphite defining a hollow chamber (4), characterized in that it comprises at least the steps of:
mixing powders,
placing the previously mixed powders in a closed container (5) in an insulating ceramic material and housed in the hollow chamber (4),
performing the spark plasma sintering operation, and
obtaining a pellet of the compound of MAX phase type.

15. The process according to claim 14, wherein the container (5) is alumina-based.

16. The process according to claim 14, wherein the powders are not in contact with the two punches (3a,3b), are not directly subjected to the applied current and are insulated from the applied pressure, the current and the pressure being those applied during the spark plasma sintering operation.

17. The process according to claim 14, wherein the spark plasma sintering operation comprises a heat cycle during which at least one heating rate greater than 60° C./min is applied.

18. The process according to claim 17, wherein the heat cycle comprises:
a first temperature rise at a heating rate greater than 60° C./min, to a temperature comprised between 550°° C. to 700°° C. hold for a period comprised between 2 to 15 minutes, followed by
a second temperature rise at a heating rate greater than 60° C./min to a temperature comprised between 1400°° C. to 1500°° C. hold for a period comprised between 5 to 15 minutes.

19. A compound of MAX phase type having the general formula Mₙ₊₁AXₙ, where n=1, 2 or 3, M is selected from among Ti, V, Cr, Zr, Nb, Mo, Hf, Sc, Mn, Y and Ta, A is selected from among Al, Si, P, S, Ga, Ge, As, Cd, In, Sn, Tl and Pb, and X is C or N, wherein it is obtained with the process according to claim 14, it is in the form of a pellet having porosity greater than 30%, preferably greater than 40% and its element ratio of M/X is stoichiometric within a relative error lower than plus/minus 0.5%.

20. The compound of MAX phase type according to claim 19, wherein it has the formula Ti₃AlC₂.

21. The compound of MAX phase type according to claim 19, whose morphology mostly presents the two following types of particle sections:
rectangular flat sections with a length comprised between 1 to 20 micrometres and a height comprised between 0.5 to 2 micrometres, and/or
rounded edge flat sections with a diagonal length comprised between 1 to 20 micrometres.

22. A spark plasma sintering device to implement the process of claim 14, comprising a die (2) in graphite and two punches (3a,3b) in graphite defining a hollow chamber (4), wherein it also comprises a closed container (5) in insulating ceramic material, for example alumina, positioned in the hollow chamber (4), intended to receive the powder mixture during application of the spark plasma sintering process and able to maintain the powder mixture not directly subjected to the applied current and insulated from the applied pressure, the current and the pressure being those applied during the spark plasma sintering operation.

23. A compound of general formula Mₙ₊₁Xₙ, where n=1, 2 or 3, and wherein M is selected from the group consisting of Ti, V, Cr, Zr, Nb, Mo, Hf, Sc, Mn, Y and Ta, and X is selected from the group consisting of C and N, characterized in that the compound is fabricated from a compound of MAX phase type according to any of claim 19.

24. A compound of general formula Mₙ₊₁XₙTₓ according to claim 23, where n=1, 2 or 3, and M is selected from among the group consisting of Ti, V Cr, Zr, Nb, Mo, Hf, Sc, Mn, Y and Ta, and X is selected from the group consisting of C and N, and where T corresponds to a terminal group selected from the group consisting of O, OH, F, a halogen other than F, S, and a chalcogen other than S, characterized in that the compound is in the form of crystals mostly having a general tablet shape, said tablets comprising two opposite parallel surfaces of defined length (L) spaced apart by a defined height (H), and in that:
the length of the crystals in tablet form is between 1 and 15 micrometres,
the height H of the crystals in tablet form is between 0.2 and 1 micrometre, and
the flattening aspect ratio of the crystals in tablet form defined by the ratio between the length L and height H is between 5 and 50.

25. The compound according to claim 24, wherein it has the formula Ti₃C₂Tₓ.

26. A process for fabricating the compound according to f claim 24, wherein it comprises two chemical attack steps of the precursor compound of MAX phase type with an aqueous acid solution.

27. (canceled)

28. A compound of general formula Mₙ₊₁Xₙ, where n=1, 2 or 3, and wherein M is selected from the group consisting of Ti, V, Cr, Zr, Nb, Mo, Hf, Sc, Mn, Y and Ta, and X is selected from the group consisting of C and N, characterized in that the compound is obtained by the process of claim 14.
